(19) United States
(12) Patent Application Publication
(10) Pub. No.: US 2006/0224894 A1
(43) Pub. Date: Oct. 5, 2006

(54) Methods, devices and computer programs for creating ciphertext, plaintext and a cryptographic key

(75) Inventors: Gopal R. Srinivasa, Bangalore (IN); Anil Kumar Bathula, Bangalore (IN); Ashwini Kumar Tambi, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/297,441

(22) Filed: Dec. 9, 2005

(30) Foreign Application Priority Data
Dec. 10, 2004 (GB) 0427053.4

(51) Int. Cl. H04L 9/00

(52) U.S. Cl. 713/171; 713/181

(57) ABSTRACT

In an embodiment of a method of creating ciphertext, the embodiment includes the step of providing an authority with a piece of information that is associated with an entity. The embodiment also includes the step of acquiring from the authority a cryptographic key that is based on the piece of information. In addition to the previous two steps, the embodiment includes the step of encrypting plaintext with an encryption process that uses the cryptographic key to thereby create the ciphertext.

### FIELD OF THE INVENTION

The present invention relates generally to methods, devices and computer programs for creating ciphertext, plaintext and a cryptographic key, and has particular—but by no means exclusive—application to maintaining the integrity of software.

### BACKGROUND OF THE INVENTION

Modifying software is a relatively straightforward task and there are a myriad of software development tools that can be used to modify software. The ability to modify software is generally desirable because it allows developers to easily enhance software. For instance, software can be readily modified to remove bugs or add new functionality. Whilst there are many benefits that flow from being able to easily modify software, there are downsides. One notable downside is that unscrupulous software developers often modify a third party's software to include malicious code such as a virus. It is therefore desirable to have in place a mechanism for maintaining the integrity of software so that users of software are provided with a level of protection against the vagaries of unscrupulous software developers.

### SUMMARY OF THE INVENTION

In an embodiment of a method of creating ciphertext, the embodiment includes the step of providing an authority with a piece of information that is associated with an entity. The embodiment also includes the step of acquiring from the authority a cryptographic key that is based on the piece of information. In addition to the previous two steps, the embodiment includes the step of encrypting plaintext with an encryption process that uses the cryptographic key to thereby create the ciphertext.

The present invention will be more fully understood from the following description of a specific embodiment. The description is provided with reference to the accompanying figures.

### BRIEF DESCRIPTION OF THE FIGURES

FIG. 1 is a schematic diagram of a system embodying the present invention;

FIG. 2 is a flow chart of an encryption process used by the system of FIG. 1;

FIG. 3 is a flow chart of a process that the system of FIG. 1 uses to generate a cryptographic key; and

FIG. 4 is a flow chart of a decryption process used by the system of FIG. 1 to decrypt encrypted software.

### DETAILED DESCRIPTION

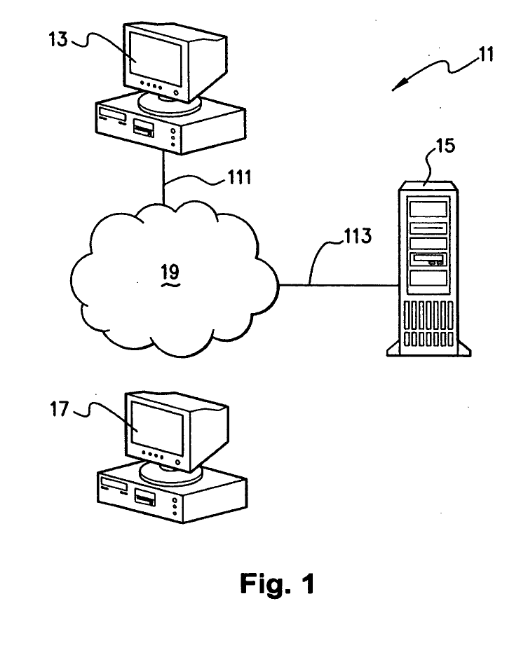

With reference to FIG. 1, a system 11 embodying the present invention comprises a first personal computer 13 that is operated by an entity that is involved in distributing software; a computer server 15 that is under the control of a trusted authority; a second personal computer 17; and a communication network 19;

The first personal computer 13 is used by the entity to encrypt software so that unscrupulous software developers cannot readily modify the software to include malicious code. To enable the first personal computer 13 to encrypt the software the first personal computer 13 is made up of numerous components that cooperate with each other. These components include: a power supply; motherboard; random access memory; a video card; a monitor; a network interface; and a hard disk loaded with the Microsoft XP operating system and an encryption application. The encryption application is responsible for performing the actual task of encrypting the software and basically relies on the other components of the first personal computer 13 to provide an environment in which the encryption application can be executed. The first personal computer 13 is arranged such that a person can selectively invoke and close down the encryption application via a graphical user interface that the Microsoft XP operating system provides.

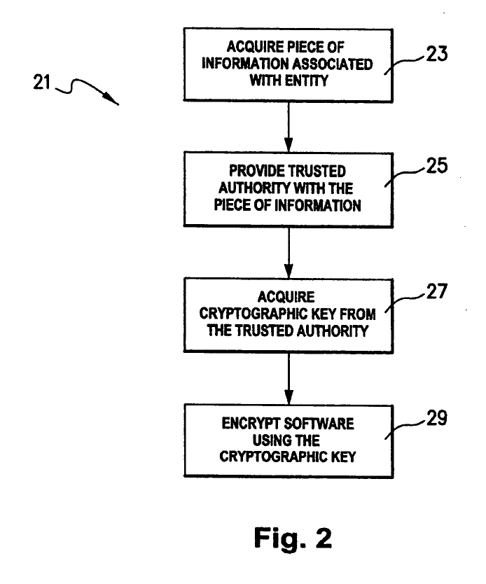

The various steps that the encryption application performs when encrypting software are shown in the flow chart 21 of FIG. 2. The first step 23 that the encryption application performs is to acquire a piece of information that is associated with the entity, which in the present embodiment is an e-mail address of the entity. To acquire the piece of information the encryption application is arranged to effect the presentation of a dialogue box on the monitor of the first personal computer 13. The dialogue box is such that is issues a visual prompt for the user of the first personal computer 13 to type in the piece of information that is associated with the entity. By examining the dialogue box the encryption application is able to acquire the piece of information.

Subsequent to the step 23 of acquiring the piece of information, the encryption application proceeds to carry out the step 25 of providing the trusted authority with the piece of information. The first personal computer 13 effects this step 25 by using the network interface to supply the piece of information to the communication network 19, which in turn transfers the piece of information to the computer server 15. To supply the communication network 19 with the piece of information, the network interface of the first personal computer 13 is connected to a communication link 111 that is connected to the communication network 19. In the present embodiment of the system 11 the communication link 111 is in the form of an xDSL link.

On completing the step 25 of providing the authority with the piece of information, the encryption application proceeds to carry out the step 27 of acquiring a cryptographic key from the trusted authority. To acquire the cryptographic key the encryption application interacts with the network interface of the first personal computer 13 to obtain the cryptographic key therefrom. The network interface receives the cryptographic key from the computer server 15 via the communication network 19. Details on how the cryptographic key is created are provided in subsequent paragraphs of this description.

Once the encryption application has carried out the step 27 of acquiring the cryptographic key, the encryption application performs the step 29 of encrypting the software. Before actually encrypting the software, the encryption application presents another dialogue box on the monitor of the first personal computer 13. This dialogue box issues a prompt for the file name of the software that is to be encrypted. Once the user of the first personal computer 13 has typed the file name into the dialogue box, the encryption application checks the dialogue box to determine the file name and proceeds to locate the software identified by the file name entered into the dialogue box. Once the software has been located, the encryption application proceeds to perform the actual step 29 of encrypting the software to effectively transform the software from plaintext to ciphertext. To encrypt the software, the step 29 of encrypting the software involves processing the software in accordance with the Advanced Encryption Standard (AES) algorithm. The encryption application uses the cryptographic key that is previously acquired (in step 27) to initialise the AES algorithm.

Once the entity has encrypted the software using the first personal computer 13, it is envisaged that the entity would distribute the encrypted software by, for example, allowing the encrypted software to be downloaded via the Internet and/or by shipping CDROMs (or other portable computer readable mediums) that contain the encrypted software.

Encrypting the software protects its integrity by virtue of the fact that encrypted software is very difficult (if not impossible) for software developers to read and understand, which is critical if a developer is to modify software in a required manner.

An advantage of the present embodiment of the invention is that the entity can only effect installation of the software if it registers with the trusted authority. The registration process is effectively performed by the step 25 of providing the trusted authority with the piece of information. Unless the entity registers with the trusted authority, the entity is unlikely to obtain the necessary cryptographic key (which is received during step 27) that will enable the encrypted software to be decrypted using the second personal computer 17.

In the present embodiment of the invention the encryption application does not actually perform steps 23 to 27 each time it wishes to encrypt software. The encryption application will typically only perform steps 23 to 27 once, after which it can perform the step 29 of encrypting the software multiple times uses the same cryptographic key.

As indicated previously, the first personal computer 13 acquires the cryptographic key from the computer server 15 via the communication network 19. In order to facilitate this function the computer server 15 includes several components that cooperate with each other. These components include: a power supply; motherboard; random access memory; a network interface; and a hard disk loaded with the HP-UX operating system. In addition to the HP-UX operating system, the hard disk is also loaded with a key generation application.

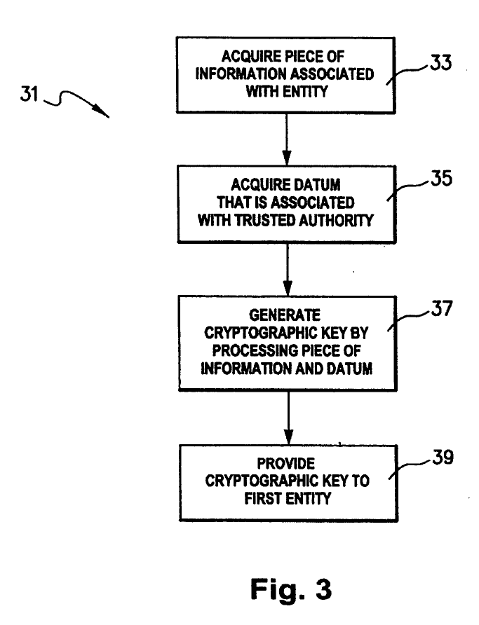

The key generation application is essentially arranged to generate and provide the cryptographic key that is acquired by the first personal computer 13. To provide this operation the key generation application is arranged to carry out the steps shown in the flow chart 31 of FIG. 3. In this regard, the first step 33 that the key generation application performs is to acquire the piece of information that is associated with the entity. As described in the preceding paragraphs of this specification, the first personal computer 13 uses the communication network 19 to transfer the piece of information to the computer server 15. Consequently, the key generation application is arranged to interact with the network interface of the computer server 15 to acquire the piece of information via the communication network 19. The network interface of the computer server 15 is connected to the communication network 19 via a communication link 113 in the form of a xDSL link.

Once the key generation application has acquired the piece of information that is associated with the entity, the key generation application carries out the step 35 of acquiring a datum that is associated with the trusted authority. In the present embodiment the datum is in the form of a 128-bit string that is the result of processing another string using the MD-5 hashing algorithm. The key generation application carries out the step 35 of acquiring the datum by reading the datum from the hard disk of the computer server 15.

Upon carrying out the steps 33 and 35 of acquiring the piece of information and the datum, the key generation application carries out the actual step 37 of creating the cryptographic key. The key generation application creates the cryptographic key by hashing the acquired piece of information and the datum using the MD-5 hashing algorithm.

Once the key generation application has completed the step 37 of generating the cryptographic key, the key generation application performs the final step 39 of providing the cryptographic key to the first personal computer 13. To do this the key generation application supplies the network interface of the computer server 15 with the cryptographic key. On receiving the cryptographic key the network interface provides the key to the communication network 19, which in turn transfers the cryptographic key to the first personal computer 13.

To enable the first personal computer 13 and the computer server 15 transfer information between each other (for example, the cryptographic key), the communication network 19 includes numerous interconnected TCP/IP based routers that form the Internet.

The second personal computer 17 can be used by a person to decrypt software that has been encrypted using the first personal computer 13. To provide this service the second personal computer 17 is made up of numerous components that cooperate with each other. These components include: a power supply; motherboard; random access memory; a video card; a monitor; a CDROM drive; and a hard disk loaded with the Microsoft XP operating system and a decryption application. The decryption application is responsible for performing the actual task of decrypting encrypted software and basically relies on the other components of the second personal computer 17 to provide an environment in which the decryption application can be executed. The second personal computer 17 is arranged such that a person can selectively invoke and close down the decryption application via a graphical user interface that the Microsoft XP operating system provides.

When a person wishes to decrypt software that has been encrypted by the first personal computer 13, the person can decrypt the software by initially loading the encrypted software onto the second personal computer 17. This can be achieved, for example, by simply inserting into the CDROM drive of the second personal computer 17 a CDROM containing the encrypted software or alternatively downloading the encrypted system software from the communication network 19. The person would then invoke the decryption application, which is capable of presenting a dialogue box on the monitor of the second personal computer 17. The dialogue box prompts the person to type into the dialogue box the filename of the encrypted software on the CDROM (or that has been downloaded from the communication network 19), which was previously inserted into the CDROM drive. The decryption application uses the filename typed into the dialogue box to locate the encrypted software.

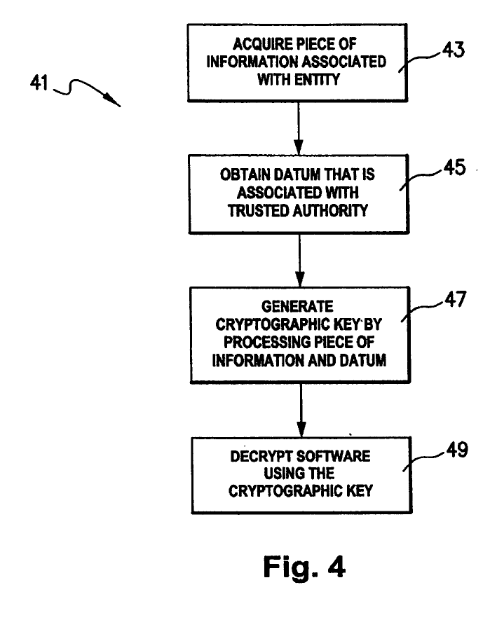

Subsequent to locating the encrypted software, the decryption application proceeds to decrypt the software by performing the various steps shown in the flow chart 41 of FIG. 4. In this regard, the first step 43 that the decryption application performs is to acquire the piece of information that is associated with the entity, which as indicated in the previous paragraphs is the e-mail address of the entity. As described in the preceding paragraphs, the piece of information associated with the entity is used by the computer server 15 in the process of creating the cryptographic key. The decryption application acquires the piece of information that is associated with the entity by reading a data file that is associated with the encrypted software. If the encrypted software is contained on a CDROM the data file would be contained on the CDROM as well.

The next step 45 that the decryption application performs is to obtain the datum that is associated with the trusted authority. As indicated previously, the datum is in the form of a 128-bit string and is used by the computer server 15 in the process of generating the cryptographic key. The decryption application is ‘hard-coded’ with a data structure that represents the datum. Thus, the decryption application is arranged to acquire the datum by reading the hard coded data structure.

Once the decryption application has acquired the piece of information and the datum, the next step 47 that it performs is to generate the cryptographic key that the first personal computer 13 uses to encrypt the software. As described in the preceding paragraphs, the computer server 15 generated the cryptographic key using the MD-5 hashing algorithm. Consequently, the decryption application generates the cryptographic key by hashing the piece of information and the datum (which were acquired during steps 43 and 45) using the MD-5 algorithm to generate the cryptographic key.

Subsequent to generating the cryptographic key, the decryption application proceeds to perform the actual step 49 of decrypting the encrypted software. To decrypt the software, the decryption application processes the encrypted software in accordance with the AES algorithm to effectively transform the encrypted software from ciphertext to plaintext. As described previously, the AES algorithm is used by the first personal computer 13 to encrypt the software.

The decryption application can also check the decrypted software to authenticate the entity. If on checking the decrypted software the software is garbled, this indicates that another party is possibly masquerading as the entity. On the other hand, if the decrypted software is not garbled, this indicates that the entity is actually the entity. An advantage of this over existing techniques is that it can be used to ensure that only authentic entities can install software on customer machines.

It is noted that there are alternative embodiments of the present invention. It is envisaged that in these alternative embodiments the AES algorithm may not be used to encrypt and decrypt the software. Instead algorithms such as DES, triple-DES, or IDEA could be used. Furthermore, the alternative embodiments of the present invention may not use the MD-5 hashing algorithm to generate the cryptographic key. Instead, hashing algorithms such as SHA, HAVAL or RIPE-MD could be used.

Whilst in the present embodiment of the invention the piece of information that is associated with the entity is in the form of an e-mail address, it is envisaged that other forms of information associated with the entity could be employed. For example, the piece of information could include a telephone number or street address. It is also noted that whilst in the present embodiment of the invention the datum associated with the trusted entity is in the form of a 128-bit string that is the result of a hashing process, the datum could be in different forms in the alternative embodiments. For example, the datum may be a sequence of numbers from a pseudo-random number generator.

It is noted that the previous description in relation to steps 23 and 25 indicates that it is the actual encryption application that perform steps 23 and 25. In an alternative embodiment of the invention steps 23 and 25 may be performed by, for example, a person logging onto a web site operated by the trusted authority and using the web site to supply and obtain respectively the piece of information and the cryptographic key.

Persons skilled in the art will readily appreciate that whilst the previous description of the embodiment of the invention identifies only the XP and HP-UX operating systems, it is possible to use the present invention in conjunction with alternative operating systems and as Linux, SunOS, and MacOS.

The present invention is not restricted to being used with the personal computers 13 and 17. The present invention can be used in conjunction with a range of computing devices from Personal Digital Assistants (PDAs) to high-end server computers.

Whilst the embodiment of the present invention has been described in the context of encrypting software, it is noted that the present invention is not restrict to encrypting software and has application to encrypting a range of data including digital audio and video.

What is claimed is:

1. A method of creating ciphertext, the method comprising the steps of:
providing an authority with a piece of information that is associated with an entity;
acquiring from the authority a cryptographic key that is based on the piece of information; and
encrypting plaintext with an encryption process that uses the cryptographic key to thereby create the ciphertext.

2. The method as claimed in claim 1, wherein the cryptographic key is a result of a key generation process that uses the piece of information and a datum associated with the authority.

3. The method as claimed in claim 2, wherein the key generation process comprises a hashing algorithm.

4. The method as claimed in claim 3, wherein the hashing algorithm comprises an MD-5 algorithm.

5. The method as claimed in claim 2, wherein the datum comprises a result of hashing data.

6. The method as claimed in claim 1, wherein the piece of information comprises an e-mail address for the entity.

7. The method as claimed in claim 1, wherein the plaintext comprises software.

8. The method as claimed in claim 1, wherein the encryption process comprises an Advanced Encryption Standard (AES) algorithm.

9. A method of creating a cryptographic key, the method comprising the steps of:
acquiring a piece of information that is associated with an entity;
acquiring a datum that is associated with an authority; and
processing the piece of information and the datum with a key generation process to create the cryptographic key.

10. The method as claimed in claim 9, further comprising the step of providing the cryptographic key to the entity for use with an encryption process.

11. The method as claimed in claim 10, wherein the encryption process comprises an Advanced Encryption Standard (AES) algorithm.

12. The method as claimed in claim 9, wherein the piece of information comprises an e-mail address for the entity.

13. The method as claimed in claim 9, wherein the datum comprises a result of hashing data.

14. The method as claimed in claim 9, wherein the key generation process comprises a hashing algorithm.

15. The method as claimed in claim 14, wherein the hashing algorithm comprises an MD-5 algorithm.

16. A method of creating plaintext, the method comprising the steps of:
acquiring a piece of information that is associated with an entity; and
decrypting ciphertext with a decryption process that has access to a datum that is associated with an authority, the decryption process being operable to process the piece of information and the datum with a key generation process to create a cryptographic key, the decryption process being further operable to decrypt the ciphertext with a decryption process that uses the cryptographic key to thereby create the plaintext.

17. The method as claimed in claim 16, further comprising the step of processing the plaintext to authenticate theentity.

18. The method as claimed in claim 16, wherein the piece of information comprises an e-mail address for the entity.

19. The method as claimed in claim 16, wherein the datum comprises a result of hashing data.

20. The method as claimed in claim 16, wherein the key generation process comprises a hashing algorithm.

21. The method as claimed in claim 16, wherein the hashing algorithm comprises an MD-5 algorithm.

22. The method as claimed in claim 16, wherein the decryption process comprises an Advanced Encryption Standard (AES) algorithm.

23. The method as claimed in claim 16, wherein the ciphertext comprises encrypted software.

24. A device for creating ciphertext, the device comprising:
a transmitter for providing an authority with a piece of information that is associated with an entity;
a receiver for acquiring from the authority a cryptographic key that is based on the piece of information; and
an encryptor for encrypting plaintext with an encryption process that uses the cryptographic key to thereby create the ciphertext.

25. The device as claimed in claim 24, wherein the cryptographic key is a result of a key generation process that uses the piece of information and a datum associated with the authority.

26. The device as claimed in claim 25, wherein the key generation process comprises a hashing algorithm.

27. The device as claimed in claim 26, wherein the hashing algorithm comprises an MD-5 algorithm.

28. The device as claimed in claim 25, wherein the datum comprises a result of hashing data.

29. The device as claimed in claim 24, wherein the piece of information comprises an e-mail address for the entity.

30. The device as claimed in claim 24, wherein the plaintext comprises software.

31. The device as claimed in claim 24, wherein the encryption process comprises an Advanced Encryption Standard (AES) algorithm.

32. A device for creating a cryptographic key, the device comprising:
a receiver for acquiring a piece of information that is associated with an entity, and a datum that is associated with an authority; and
a processor for processing the piece of information and the datum with a key generation process to create the cryptographic key.

33. The device as claimed in claim 32, further comprising a transmitter for providing the cryptographic key to the entity for use with an encryption process.

34. The device as claimed in claim 33, wherein the encryption process comprises an Advanced Encryption Standard (AES) algorithm.

35. The device as claimed in claim 32, wherein the piece of information comprises an e-mail address for the entity.

36. The device as claimed in claim 32, wherein the datum comprises a result of hashing data.

37. The device as claimed in claim 32, wherein the key generation process comprises a hashing algorithm.

38. The device is claimed in claim 37 wherein the hashing algorithm comprises an MD-5 algorithm.

39. A device for creating plaintext, the device comprising:
a receiver for acquiring a piece of information that is associated with an entity; and
a decryptor for decrypting ciphertext with a decryption process that has access to a datum that is associated with an authority, the decryption process being operable to process the piece of information and the datum with a key generation process to create a cryptographic key, the decryption process being further operable to decrypt the ciphertext with a decryption process that uses the cryptographic key to thereby create the plaintext.

40. The device as claimed in claim 39, further comprising a processor for processing the plaintext to authenticate the entity.

41. The device as claimed in claim 39, wherein the piece of information comprises an e-mail address for the entity.

42. The device as claimed in claim 39, wherein the datum comprises a result of hashing data.

43. The device as claimed in claim 39, wherein the key generation process comprises a hashing algorithm.

44. The device as claimed in claim 43, wherein the hashing algorithm comprises an MD-5 algorithm.

45. The device as claimed in claim 39, wherein the decryption process comprises an Advanced Encryption Standard (AES) algorithm.

46. The device as claimed in claim 39, wherein the ciphertext comprises encrypted software.

47. A computer program comprising instructions for causing a computing device to carry out the method as claimed in claim 1.

48. A computer program comprising instructions for causing a computing device to carry out the method as claimed in claim 9.

49. A computer program comprising instructions for causing a computing device to carry out the method as claimed in claim 16.

50. Ciphertext that has been created using the method as claimed in claim 1.

51. A cryptographic key that has been created using the method as claimed in claim 9.

52. Plaintext that has been created using the method as claimed in claim 16.
